(19) United States
(12) Patent Application Publication
(10) Pub. No.: US 2026/0267992 A1
(43) Pub. Date: Sep. 10, 2026

(54) PRIVACY-PRESERVING DECENTRALIZED METHOD AND SYSTEM TO REMOTELY CERTIFY THE STATE OF AN UNTRUSTED ENDPOINT

(71) Applicant: EDAMAME TECHNOLOGIES, CHÂTENAY-MALABRY (FR)

(72) Inventor: Frank LYONNET, CHÂTENAY-MALABRY (FR)

(73) Assignee: EDAMAME TECHNOLOGIES, CHÂTENAY-MALABRY (FR)

(21) Appl. No.: 19/166,274

(22) PCT Filed: Mar. 15, 2024
(86) PCT No.: PCT/EP2024/057055

§ 371 Date: Sep. 17, 2025

(30) Foreign Application Priority Data
Mar. 17, 2023 (FR) 2302518

(51) Int. Cl. G06F 21/57; H04L 9/40

(52) U.S. Cl. CPC G06F 21/577; H04L 63/0478; H04L 63/1433

(57) ABSTRACT

A method remotely certifies a State (S) of an Endpoint, whose trust is not established, from a Backend, involving an Endpoint Orchestrator and at least one Endpoint Validator to attest the plausibility (P) of the State. The State is based on a series of State Validations (SVi) and a State Function (SF), such that S=SF (SVi). The State isand the State Function are known to the Backend and the Endpoint. The series of State Validations are unknown to the Backend but known to the Endpoint. The method comprises verifying the Plausibility with the following conditions: the Plausibility represents an analysis of information within the Endpoint that supports the accuracy of the State, is known to the Backend through the Endpoint Orchestrator, and is based on a series of Plausibility Validations (PVj) and a Plausibility Function (PF), such that P=PF (PVj).

### [1] TECHNICAL FIELD OF THE INVENTION

The invention concerns a method and a system to remotely certify the State (S) of an untrusted Endpoint (E). This certification can be performed without invasive verifications that would lead to a breach of privacy or confidentiality. The invention is in the field of decentralized privacy-preserving computation and certification of the endpoint state (in particular, but not limited to the endpoint security posture, or indicators resulting of analytics of metrics collated by the endpoint in a context of Internet of Things applications, in particular health applications).

The goal is to remotely certify the State (S) of an Endpoint (E) that trust is not established.

In particular, one goal is to certify that the Security Posture (SP) of such an Endpoint (E) trying to access one or more remote Resource (R) is compliant with different security policies as it accesses this Resource (R). For example, the security policies can include installed software pre-requisites or system configurations aiming at improving the Security Posture (SP) of the Endpoint (E) as it accesses the Resource (R).

The invention can be applied to other properties describing the State (S) of the Endpoint (E) and is not limited to the Security Posture (SP). Another goal is to certify the validity of an Health Indicator (HI) resulting of analytics of metrics collated by the endpoint in a context of Internet of Things applications, in particular human beings health applications, without exposing private of confidential information. For example, the Health Indicator (HI) can be a mental or physical score considered as public, and the metrics (Mi) can encompass biometric or behavioral records considered as private.

By certification of the State (S), we mean regularly computing the State (S) but also proving its accuracy and exposing its value to the Owner (OR) of the Resource (R). Through that certification, a State (S) matching the expectation of an Owner of Resources (OR) can safely be used to authorize or deny access in a dynamic fashion to the Resource (R).

Unlike with existing solutions, we want this certification to be possible for all types of Endpoints (E), including Endpoints (E) not belonging to and controlled by the Owner of Resources (OR) and therefore untrusted by the Owner (OR). We want to do that in a fashion that is extremely hard to tamper with to provide the Owner of Resources (OR) a strong confidence in the computation of the State (S) of the Endpoint (E). And we want to do that while providing a total guarantee of the privacy or confidentiality of the Endpoint Data (ED) used to perform the said certification.

### [7] BACKGROUND OF THE INVENTION

According to the state-of-the-art, a solution would be to achieve the certification of a State (S) for an Endpoint (E), like its Security Posture (SP) or Health Indicator (HI), by allowing arbitrary and dynamic access of Endpoint Data (ED) by the Owner of Resources (OR) through a Backend (B) combined with a Software Agent (SA) running on the Endpoint (E) for the purpose of remote attestation and other analysis mechanisms. Traditionally, the Endpoint (E) would run a Unified Endpoint Management (UEM) solution formed by a Software Agent (SA) running on the Endpoint (E) and a Backend (B), where the Software Agent (SA) is totally controlled by the Backend (B).

However, arbitrary access to the Endpoint Data (ED) by the Owner of Resources (OR) is only possible when:
the Endpoint (E) is owned by the Owner of Resources (OR) and centrally managed by the Owner of Resources (OR); and
the Endpoint (E) is not used by the Endpoint User (EU) for personal reasons, since the control of the Endpoint (E) implied by Unified Endpoint Management (UEM) would violate the privacy of the Endpoint User (EU); and
the Endpoint (E) is not used by the Endpoint User (EU) to access multiple Resources (R), since the control of the Endpoint (E) implied by Unified Endpoint Management (UEM) would violate confidentiality. For example, one Resource (R1) belonging to an Owner (OR1) and another Resource (R2) belonging to an owner (OR2) would be both accessible to bother Owners (OR1) and (OR2).

A broader solution to this problem, covering Endpoints (E) that are not owned by the Owner (OR), is to implement this scheme on Endpoints (E) that are under control of a trusted Third Party (TP), potentially using Unified Endpoint Management (UEM). The Third Party (TP) could certify the State (S) to the Owner of Resources (OR) by accessing the Endpoint Data (ED) while ensuring the Endpoint User (EU) that the Endpoint data (ED) is never exposed to the Owner (OR). However, when using such a Third Party (TP), the direct access of the Endpoint Data (ED) by the Third Party (TP) still poses a high degree of risk to the privacy or confidentiality requirements of the Endpoint User (EU).

A solution to mitigate privacy risks would be to perform certification of the State (S) within the Endpoint (E) itself. However, the guarantees offered by using the Endpoint (E) for the analysis of its own security are very low. Indeed, such a scheme would be extremely easy to tamper with, especially in a scenario where the Endpoint (E) is not owned by the Owner (OR).

Some prior art techniques are described in US20220329585A1, US20220321362A1 and US20190199530A1.

### SUMMARY OF THE INVENTION

The aim of the invention is to provide improved method and system for the remote certification by an Owner of Resources (OR) of the State (S) of any Endpoint (E), in particular, Endpoints (E) that are under the sole control of the Endpoint User (EU) and not managed by Unified Endpoint Management (UEM) and therefore not trusted by the Owner of Resources (OR).

To this end, the invention concerns a method to remotely certify the State (S) of an Endpoint (E) from a Backend (B), involving an Endpoint Orchestrator (EO) and at least one Endpoint Validator (EV) to attest the plausibility (P) of the State (S), wherein:
the Endpoint Validator(s) (EV) is/are distinct from the Endpoint Orchestrator (EO),
the State (S) is based on a series of State Validations (SVi) and a State Function (SF), such that S=SF (Svi),
the State (S) is known to the Backend (B) and the Endpoint (E),
the State Function (SF) is known to the Backend (B) and the Endpoint (E),
the series of State Validations (SVi) are unknown to the Backend (B) but known to the Endpoint (E), and wherein the method comprises a step of verifying the Plausibility (P) of the State (S) with the following conditions:
the Plausibility (P) represents an analysis of information within the Endpoint (E) that supports the accuracy of the State (S),
the Plausibility (P) is known to the Backend (B) through Endpoint Orchestrator (EO),
the Plausibility (P) is based on a series of Plausibility Validations (PVj) and a Plausibility Function (PF), such that P=PF (PVj),
the Plausibility Function (PF) and the Plausibility Validations (PVj) are updated in a dynamic fashion,
individual Plausibility Validations (PVj) are unknown to the Backend (B), to protect privacy of the Endpoint (E),
the Plausibility Function (PF) is unknown to the Endpoint (E), to make tampering of the Plausibility (P) difficult,
the Plausibility Function (PF) is computed by the Endpoint Orchestrator (EO),
the Plausibility Validations (PVj) are computed by the Endpoint Validator(s) (EV) based on a series of Endpoint Data (ED) that are unknown to any party except the Endpoint (E).

Thanks to the invention, we enable certification of the State (S) of any Endpoint (E), for example the Security Posture (SP) or Health Indicator (HI) of the Endpoints (E) defined by the State (S), in particular Endpoints (E) that are under the sole control of the Endpoint User (EU), without Unified Endpoint Management (UEM) or any other control by the Owner of Resources (OR). We do that by using a trusted Third Party (TP) that certifies the State (S) without accessing Endpoint Data (ED) directly. Scalable certification of the State (S) is based on the dynamic computation of a Plausibility (P) based on Plausibility Validations (PV) performed on Endpoint Data (ED). The Plausibility Validations (PV) are performed on Endpoint Validators (EV), running on secured Hosts (H), possibly including other Endpoints (E) whose State (S), in particular its Security Posture (SP) or Health Indicator (HI), has been previously certified as satisfactory and that we define as Participating Endpoints (PE). Endpoint Validators (EV) only have access to an encrypted version of the Endpoint Data (ED) to guarantee the privacy of Endpoint (E). Endpoints (E) have no knowledge of extracted information and Plausibility Validations (PV) performed to guarantee security. The trusted Third Party (TP) orchestrating the Plausibility Validations (PV) has no access to Endpoint Data (ED) but has access to the results of the Plausibility Validations (PV). The trusted Third Party (TP) can be audited to ensure no unwanted private information can be inferred from the Plausibility Validations (PV).

The method can be implemented with the following steps:
a) the Endpoint (E) seeks access to a Resource (R) owned by an Owner of Resource (OR);
b) the Endpoint (E) sends its state(S) to the Backend (B);
c) the Backend (B) requests the Endpoint Orchestrator (EO) to compute the Plausibility (P) of the State (S);
d) the Endpoint Orchestrator (EO) orders the Endpoint (E) to transmit Endpoint Data (ED) to the Endpoint Validators (EV);
e) the Endpoint (E) sends the Endpoint Data (ED) to the Endpoint Validators (EV) in a privacy preserving fashion;
f) the Endpoint Orchestrator (EO) orders the Endpoint Validators (EV) to perform Plausibility Validations (PV) based on the Endpoint Data (ED), using privacy preserving techniques;
g) the Endpoint Validators (EV) send back the result of the Plausibility Validations (PV) to the Endpoint Orchestrator (EO);
h) the Endpoint Orchestrator (EO) determines the Plausibility (P) of the State (S) based on the Plausibility Validations (PV);
i) the Endpoint Orchestrator (EO) communicates the Plausibility (P) to the Backend (B).
Access is granted to the Endpoint (E) by the Owner of Resource (OR) when both the State (S) of the Endpoint (E) issued by the Backend (B) and the Plausibility (P) of the State (S) issued by the Endpoint Orchestrator (EO) are matching expectations of the Owner of Resource (OR).

According to further aspects of the invention which are advantageous but not compulsory, such a method may incorporate one or several of the following features:
The Endpoint Validator(s) (EV) is/are made of one or more Participating Endpoints (PE) orchestrated by the Endpoint Orchestrator (EO), having a State (S′) previously certified according to the method described above.
The State (S) is a Health Indicator (HI), the State (S′) is a Security Posture (SP), and the Endpoint Validator(s) (EV) for validating the Health Indicator (HI) is/are made of one or more Participating Endpoints (PE) orchestrated by the Endpoint Orchestrator (EO), whose Security Posture (SP) has been previously certified through the method described above.
The State (S) is a Security Posture (SP).
The State (S) is a Health Indicator (HI).
An exposure of the Endpoint Data (ED) to potential unauthorized access is inverse to a proximity (PX) between the Endpoint Validator (EV) and the Endpoint (E), and the proximity (PX) is chosen inferior to a predetermined threshold.
The proximity (PX) is a geographical parameter. In other words, the proximity (PX) is a distance between the Endpoint Validator (EV) and the Endpoint (E).
The proximity (PX) is a legal parameter. In a first case, the proximity (PX) can be related to sovereignty. For example, the proximity (PX) can be inferior to the predetermined threshold when the Endpoint Validator (EV) and the Endpoint (E) belong to the same administrative division. In a second case, the proximity (PX) can be related to an organization. For example, the proximity (PX) can be inferior to the predetermined threshold when the Endpoint Validator (EV) and the Endpoint (E) belong to the same company or group of companies.
The Plausibility Function (PF) and the Plausibility Validations (PVj) are kept secret by the Endpoint Orchestrator (EO) but can be audited for compliance to privacy of the Endpoint (E).
The Plausibility Function (PF) and the Plausibility Validations (PVj) are dynamically defined by human operators and/or software components.
The Plausibility Validations (PVj) are computed using, on one hand, a series of Endpoint Data (EDj) captured according to a series of Endpoint Data Specifications (EDSj) on the Endpoint (E) and, on another hand, a series of Parameters (PAk) only known to the Endpoint Orchestrator (EO) to make tampering of the Plausibility (P) difficult, wherein:
PVJ=PFJ (EDj, PAk),
the series of Endpoint Data Specifications (EDSj) and the series of Parameters (PAk) are available for an audit of compliance to privacy of the Endpoint (E).
The Endpoint Validator(s) (EV) only has/have access to a non-cleartext version of the Endpoint Data (EDj) and a non-cleartext version of the series of Parameters (PAk). The Plausibility Function PFj (EDj, PAk) is a function supporting operations on non-cleartext parameters such as based on Full Homomorphic Encryption or Multi Party Computation.
The Endpoint Validator(s) (EV) only has/have access to a non-cleartext version of at least part of the Endpoint Data (EDj) and a non-cleartext version of at least part of the series of Parameters (PAk). The Plausibility Function PFj (EDj, PAk) is a function supporting operations on non-cleartext parameters such as based on Full Homomorphic Encryption or Multi Party Computation.
When the Endpoint Validator (EV) is a single Participating Endpoint (PE), the Endpoint Validator (EV) has access to a non-cleartext version of the Endpoint Data (EDj) and a non-cleartext version of the series of Parameters (PAk).
When the Endpoint Validators (EV) are made of several Participating Endpoints (PE), each Endpoint Validator (EV) has access to a non-cleartext version of all or part of the Endpoint Data (EDj) and a non-cleartext version of all or part of the series of Parameters (PAk).
The Plausibility Validations PVj=PF (EDj, PAk) and the Plausibility Function (PF) is a function returning a result (R) and a Validation Computation History (VCH) that can be used for stateful computation of the Plausibility Function (PF) where the Validation Computation History (VCH) is sent to the Endpoint Orchestrator (EO) and aggregated to the series of Parameters (PAk) in an encrypted form and only readable by the Endpoint Validator(s) (EV).
The Plausibility Validations PVj=PF (EDj, PAk) and the Plausibility Function (PF) is a function enabling Privacy Preserving Pattern Matching of the Endpoint Data (EDj) and the series of Parameters (PAk) are patterns to match, where the Endpoint Validator(s) (EV) only have access to non-cleartext version of the Endpoint Data (EDj) and a non-cleartext version of the series of Parameters (PAk).

The invention also concerns a system to remotely certify the State (S) of an Endpoint (E) from a Backend (B), the system comprising an Endpoint Orchestrator (EO) and at least one Endpoint Validator (EV) to attest the plausibility (P) of the State (S), wherein:
the Endpoint Validator(s) (EV) is/are distinct from the Endpoint Orchestrator (EO),
the State (S) is based on a series of State Validations (SVi) and a State Function (SF), such that S =SF (SVi),
the State (S) is known to the Backend (B) and the Endpoint (E),
the State Function (SF) is known to the Backend (B) and the Endpoint (E),
the series of State Validations (SVi) are unknown to the Backend (B) but known to the Endpoint (E),
   and wherein the system is configured to verify the Plausibility (P) of the State (S) with the following conditions:
the Plausibility (P) represents an analysis of information within the Endpoint (E) that supports the accuracy of the State (S),
the Plausibility (P) is known to the Backend (B) through Endpoint Orchestrator (EO),
the Plausibility (P) is based on a series of Plausibility Validations (PVj) and a Plausibility Function (PF), such that P=PF (PVj),
the Plausibility Function (PF) and the Plausibility Validations (PVj) are updated in a dynamic fashion,
individual Plausibility Validations (PVj) are unknown to the Backend (B), to protect privacy of the Endpoint (E),
the Plausibility Function (PF) is unknown to the Endpoint (E), to make tampering of the Plausibility (P) difficult,
the Plausibility Function (PF) is computed by the Endpoint Orchestrator (EO),
the Plausibility Validations (PVj) are computed by the Endpoint Validator(s) (EV) based on a series of Endpoint Data (ED) that are unknown to any party except the Endpoint (E).

### BRIEF DESCRIPTION OF THE DRAWINGS

The invention will now be explained in correspondence with the annexed figures, as illustrative examples, without restricting the object of the invention. In the annexed figures:

FIG. 1 is a diagram showing the architecture of a complete solution using the invention to certify a Security Posture (SP) and expose it to customer Conditional Access Control (CAC) solutions.

FIG. 2 is a diagram showing the trust relationships between the components of the system.

FIG. 3 is a diagram showing the architecture of the system and implementation of the method.

FIG. 4 is a diagram showing the knowledge of the components.

FIG. 5 is a diagram showing an example of implementation of the method to compute a Security Posture (SP) where an Endpoint Protection Platform (EPP) is part of the security policies and where the Plausibility (P) of (SP) includes a verification of the artifacts generated by a normal activity of the (EPP).

### DETAILED DESCRIPTION OF SOME EMBODIMENTS

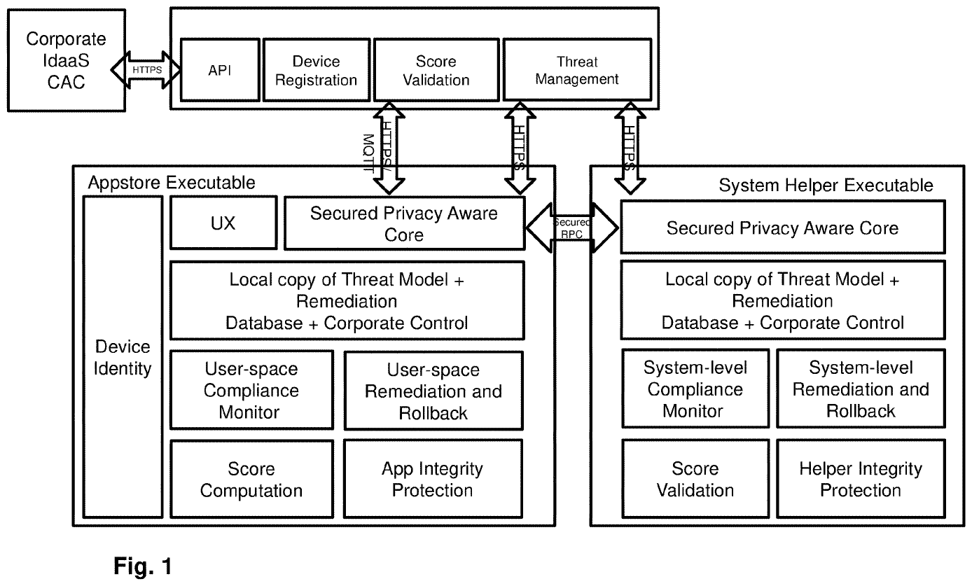

FIG. 1 illustrates a complete solution using the invention to certify a Security Posture (SP) and expose it to the Conditional Access Control (CAC) solution associated with Resources (R). The solution uses a Software Agent (SA) running on the Endpoint (E) comprised of an Appstore application and an associated system helper.

The invention allows enabling certification of a State (S) of any Endpoint (E), for example a Security Posture (SP) of the Endpoint (E), in particular Endpoints (E) that are under the sole control of the Endpoint User (EU), and therefore not managed by any

We define key requirements of the solution as follow:
a. A guarantee of security from the standpoint of an Owner of Resource (OR),
   i. a solution that provides at least the same degree of security for certification of the State (S) than a solution allowing for the dynamic and arbitrary access to the Endpoint Data (ED) like using a Unified Endpoint Management (UEM);
b. A guarantee of privacy from the standpoint of the Endpoint User (EU)
   i. a solution that limits information extraction by any party to a very simple information like a Boolean or Integer defining that the security of the Endpoint (E) expected by the Owner of Resources (OR) has or has not been reached, and
   ii. a solution that ensures that none of its component can directly access the Endpoint Data (ED) and that limits internally gathered information to elements that are well defined and cannot contain Personal Identifiable Information (PII);

The architecture enabling the combination of those two sets of requirements is defined as the Endpoint Digital Arbiter (EDA). The Endpoint Digital Arbiter (EDA) dynamically certifies the State (S) to the Owner of Resources (OR) through a Backend (B) without any components of its architecture being able to access the Endpoint Data (ED) directly except the Endpoint (E) and with a strict control and auditability of the extracted information from the Endpoint Data (ED). As a result:
the Endpoint Digital Arbiter (EDA) is trusted by the Backend (B) for security;
the Endpoint Digital Arbiter (EDA) is trusted by the Endpoint (E) for privacy.

In addition, the Endpoint Digital Arbiter (EDA) supports a decentralized model where other Participating Endpoints (PE) can contribute to the certification process of the State (S) for a given Endpoint (E).

The benefits are of the invention are:
It works on any Endpoints (E), owned, or not owned by the Owner of Resources (OR) and fully respect secrecy and privacy, allowing a hybrid personal/professional or multi-employer use of the Endpoint (E).
It enables the highest reliability of the certification of the State (S). In particular, it can go further than any other existing solution in terms of using the Endpoint Data (ED) to perform certification of the State (S) without any risk for privacy of the Endpoint User (EU).

For example, the invention can compute a Security Posture (SP) that relies on Endpoint Data (ED) that covers information from a personal environment in which the Endpoint (E) would be used, such as security related state of other elements in the personal/home Local Area Network (LAN) of the Endpoint (E). It's impossible to achieve this with Unified Endpoint Management (UEM) solutions without the Owner of Resource (OR) exposing himself to privacy liabilities.

When using the Participating Endpoints (PE), the invention minimizes the compute and storage requirements on backend components by using compute and storage from the Participating Endpoints (PE) and increases the overall solution scalability.

### Architecture of the Solution

The Endpoint Digital Arbiter (EDA) comprises an Endpoint Orchestrator (EO) component in charge of coordinating one or more Endpoint Validators (EV) components where:
The Endpoint Orchestrator (EO) maintains a list of Endpoints (E) and Endpoint Validators (EV).
The Endpoint Orchestrator (EO) oversees defining Endpoint Data Specifications (EDS) describing the Endpoint Data (ED) to extract from the Endpoint (E) and Plausibility Validations (PV) to perform on those.
Neither the Endpoint Orchestrator (EO) nor the Endpoint Validators (EV) are ever able to directly access the Endpoint Data (ED).
Only the Endpoint (E) is able to directly access the Endpoint Data (ED).
The Endpoint Orchestrator (EO) is the only component that can infer information from the Endpoint Data (ED) based on the result of the Plausibility Validations (PV).
Information inferred by the Endpoint Orchestrator (EO) from the result of the Plausibility Validations (PV) is limited and strictly controllable and auditable.

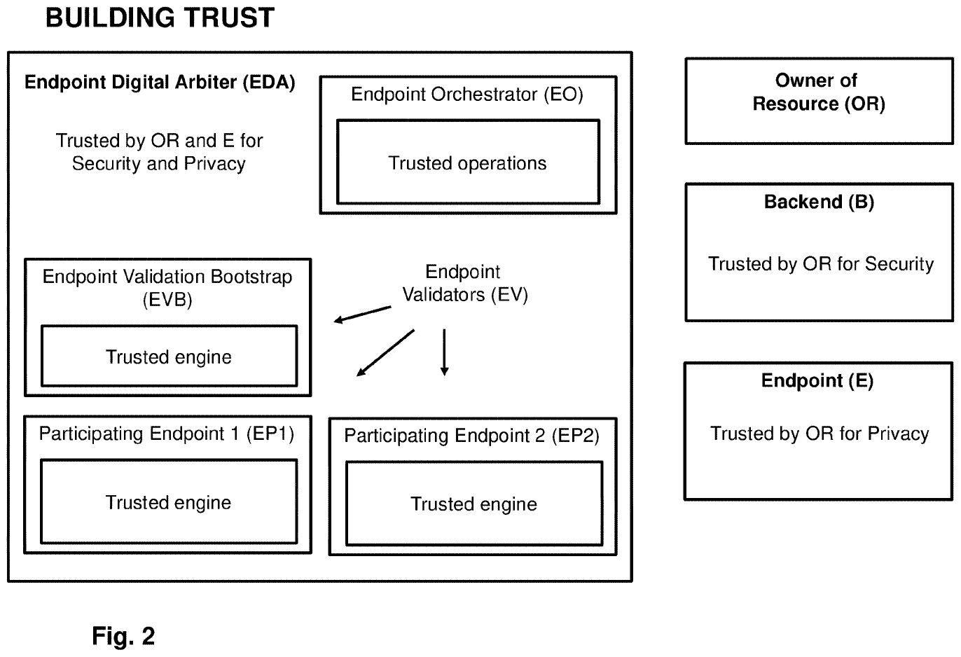

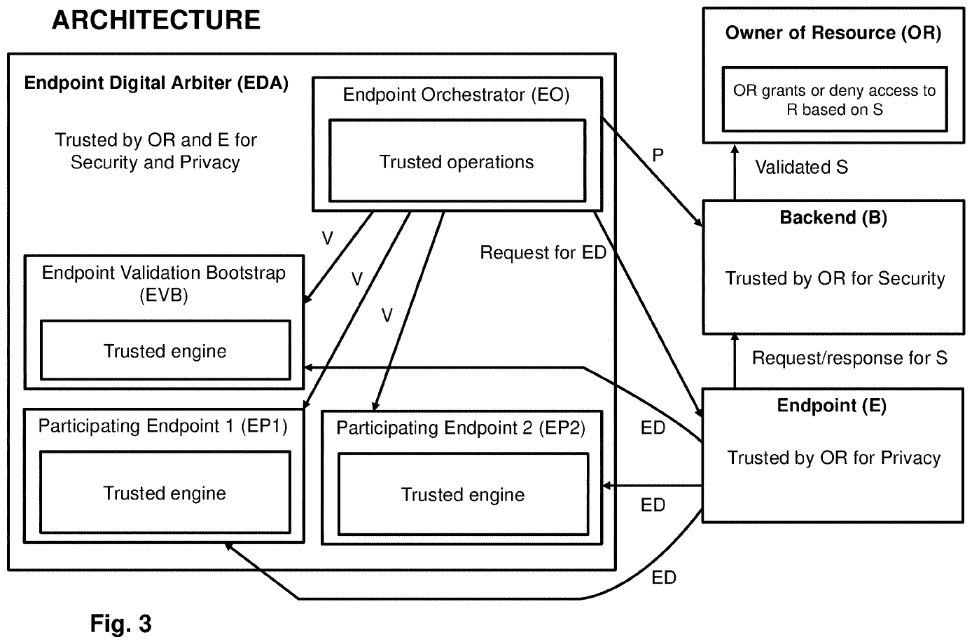

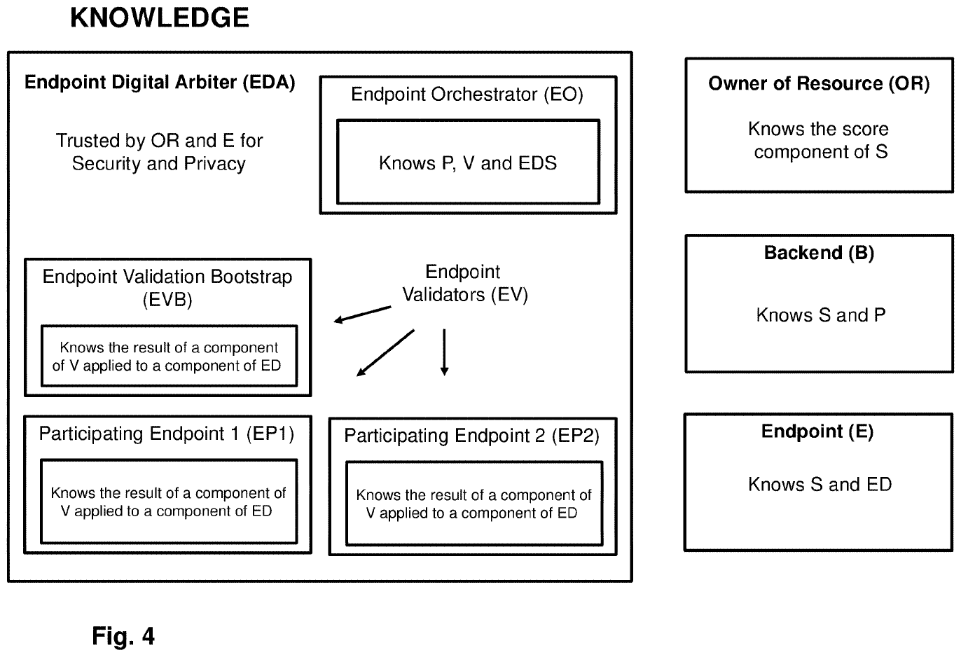

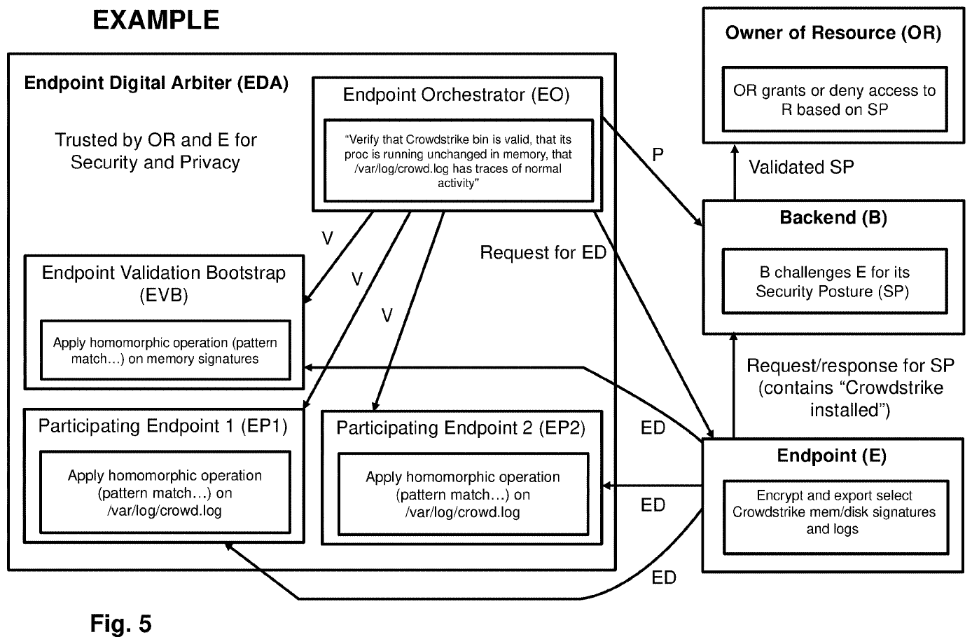

FIGS. 2 to 5 show the system, comprising the Endpoint Digital Arbiter (EDA), the Backend (B) and the Endpoint (E). The Endpoint Digital Arbiter (EDA) comprises an Endpoint Orchestrator (EO) and Endpoint Validators (EV), including an Endpoint Validation Bootstrap (EVB) and Participating Endpoint (PE). In particular, FIG. 2 illustrates the trust relationships between the components of the system; FIG. 3 illustrates the architecture of the system and implementation of the method; FIG. 4 illustrates the knowledge of the components; and FIG. 5 illustrates an example of implementation of the method, with an Endpoint Protection Platform (EPP).

The Endpoint Validators (EV) can be implemented in any Host (H), that is a Participating Endpoint (PE) or an Endpoint Validation Bootstrap (EVB), whose security has been analyzed and can be guaranteed. We define Endpoint Validation Bootstrap (EVB) as one or more instances of an Endpoint Validator (EV) satisfying those requirements using secured and controlled components operated as part of the Endpoint Digital Arbiter (EDA). We use Participating Endpoints (PE) whose Security Posture (SP) has been previously certified as other types of instances of Endpoint Validators (EV) satisfying those requirements. We forbid the Endpoint (E) as an Endpoint Validator (EV) for the certification of its own Security Posture (SP).

### Detailed Innovations of our Solution

First, we innovate in the way we certify the State (S), for example the Security Posture (SP), of the Endpoint (E). The invention could be applied to other properties describing the State (S) of the Endpoint (E) and is not limited to the Security Posture (SP). We apply some of the Internet of Things (IoT) metric certification principles to the notion of State (S) assessment and certification. Just like with Internet of Things (IoT) data, we assume that whatever the process to capture and export the data, that is the State (S) in our case, there will always be possibilities to tamper with the said process. We therefore embrace the principle of Plausibility Validations (PV) to confirm the validity of the measured data. In other words, instead of trusting the State (S) as provided by the Endpoint (E), we perform additional Plausibility Validations (PV), taking the form of a value of Plausibility (P) resulting from the capture of information from the Endpoint (E) with the goal to confirm or infirm that the State (S) is valid and has not been tampered with.

Secondly, we innovate by suppressing the risks associated with a Third Party (TP) accessing directly Endpoint Data (ED) for the purpose of the State Validation (SV). We do that using an Endpoint Orchestrator (EO) that:
Is never ever accessing the Endpoint Data (ED) directly by using external Endpoint Validators (EV).
Nor can derive unauthorized private or confidential information like Personal Identifiable Information (PII) from the Endpoint (E) through a strict control and auditability of its behavior, in particular in the definition and orchestration of Endpoint Data Specifications (EDS) and Plausibility Validations (PV).

Thirdly, we innovate by using techniques like Full Homomorphic Encryption or Multi Party Computation or Privacy Preserving Pattern Matching to perform Plausibility Validations (PV) in the Endpoint Validators (EV) without the Endpoint Data (ED) being directly accessible by the Endpoint Validators (EV).

We are solving the following problem from the mathematical standpoint. We define the State (S) of the Endpoint (E) as a series of State Validations (SVi). We define the Plausibility (P) as another series of Plausibility Validations (PVj) giving indications of the validity of the State (S), for consumption by the Owner of Resource (OR) to decide entitlements of the Endpoint (E) to the Resources (R).

Computation of the State (S): the Owner of Resource (OR) needs to know the State (S) of the Endpoint (E). In its simplest form, the State (S) is a Boolean. For example, a Security Posture (Secured/Unsecured), resulting from the evaluation of a State Function (SF) using a series of Boolean State Validations (SVi) expressing the implementation of specific security policies on the Endpoint (E). In this example, this Boolean would be used to allow or deny access to the Resource (R). But the State (S) can also be an integer for enabling for example for granting non-binary (leveled) access control to the Resource (R).

Computation of the Plausibility (P): the Owner of Resource (OR) needs to know the Plausibility (P) of the State (S). In its simplest form, the Plausibility (P) is a Boolean (Plausible/not Plausible). But the Plausibility (P) can also be an Integer. The Plausibility (P) is computed by extracting multiple Endpoint Data (EDj) from the Endpoint (E) and applying Plausibility Validations (PVj) to the Endpoint Data (Edj). For example, the Plausibility (P) can be a Plausibility Function (FP) with Plausibility Validations (PVj), as follow: P=PF (PVj) and PVj=PF2 (EDj), where PF2 is a function performing a Plausibility Validation (PVj) to an Endpoint Data (EDj).

Security: the Owner of Resource (OR) doesn't trust the Endpoint (E), such as for the security of Resource (R). We need the State (S) to be computed by the Endpoint (E), and being exposed to the Endpoint User (EU) at the same time for the sake of possible remediation (for example by asking the Endpoint User (EU) to change a specific configuration of the Endpoint (E) in order to match a required security policy), while being verifiable by the Owner of Resource (OR) through a Plausibility (P). We want to protect against tampering of the Plausibility (P) by the Endpoint (E) by making the Plausibility Function (PF) and the Plausibility Validations (PVj) unknown to the Endpoint (E).

Privacy: the Endpoint User (EU) doesn't trust any party for privacy of the Endpoint Data (ED), and we want to forbid extraction of unwanted information from the Endpoint (E) by neither the Owner of Resource (OR), nor the Endpoint Digital Arbiter (EDA), nor the Backend (B).

In the computation of the State (S), we use the Backend (B):
We explicitly expose to the Endpoint User (EU) the series of State Validations (SVi) composing a given State (S).
We forbid dynamic modifications of the list of State Validations (SVi) that would support inferring unwanted information from the Endpoint (E) using a strict control of changes.
We make State Validations (SVi) unknown to the Owner of Resource (OR), nor the Backend (B), while the State Function (SF) is known to both the Owner of Resource (OR) and the Endpoint (E).

In the computation of the Plausibility (P), we use the Endpoint Digital Arbiter (EDA):
We want the Plausibility (P) to be computed by the Endpoint Digital Arbiter (EDA) in a way that uses but never exposes the Endpoint Data (ED) to any party, including the Owner of Resource (OR), any components of the Endpoint Digital Arbiter (EDA), or the Backend (B).
We need the Plausibility Validations (PVj) to never allow to infer unauthorized information from the Endpoint (E), in particular, but not limited to, any Personal Identifiable Information (PII) by preventing the Plausibility Validations (PV) to contain any Personal Identifiable Information (PII) through a strict control of their definition.

### Detailed Description of the Technology

We introduce a novel cloud-based service enabling to define, dynamically assess and certify the State (S) of an Endpoint (E). The service uses a decentralized approach that both respects privacy by avoiding any disclosure of endpoint data or infer unauthorized information like Personal Identifiable Information (PII) to the Backend (B) or any other parties and delivers stronger security based on scalable Plausibility Validations (PV) performed by Participating Endpoints (PE), whose State (S) has been previously validated. When representing a Security Posture (SP), the certified State (S) can be used for example to safely dynamically grant or deny access to selected Resources (R).

### Definition and Computation of a State (S)

As an example, to assess the Security Posture of an Endpoint (E) we define a State (S) of the Endpoint (E) considering a combination of different State Validations (SVi) verifying the existence or the absence of specific software or configurations:
According to standardized “threat models” covering, for example:
   Operational status of security stack elements (Endpoint Protection Platforms (EPP), Endpoint Firewalls . . . )
   Status of specific, hardened Endpoint Operating System (EOS) configurations/services
   Presence of Endpoint Operating System (EOS) configurations/services that would endanger security and/or privacy
   Remote attestation of the base operating system and bootloader, such as with Apple operating system remote attestation
Accounting for multiple dimensions, for example:
   Applications: includes application authorizations, proper signing of applications, existence of installed Endpoint Protection Platform (EPP) covering application threats . . .
   Network: includes status of Endpoint Firewalls, visibility of the endpoint on the Local Area Network (LAN) such as with the enablement of response to ping . . .
   Credentials: enablement of automatic password-less login, existence of password-less screen lock . . .
   System Integrity: installed Mobile Device Management (MDM) / UEM and other 3rd party administration tools, threats making tampering easy like root kits . . .
   System Services: threats linked to system services (enabled remote access . . . )
Leveraging standards as provided for example:
   By United States of America (USA)'s Center for Internet Security (CIS)
   And other government bodies (USA's NIST, France's ANSSI . . . )
That can be customized to match specific profiles or requirements imposed by the different Owner of Resource (OR).
That is done in a normalized fashion (where the same State (S) as the same meaning across platforms/OS) The State (S) is locally computed on the Endpoint (E) and is defined as a score and its components, i.e. a series of binary State Validations (SV) of various criticality/weight.

The score can be represented as an Integer and the State Validations (SV) can be represented as a vector of Booleans with weights.

### Achieving Security Through Dynamic Plausibility Validations (PV)

The Endpoint Data (ED) are locally gathered on the Endpoint (E) as a list of byte sequences (strings, binaries, hashes . . . ) taken from specific locations defined as Endpoint Data Specifications (EDS) describing portions of memory, disk or other resources owned by the Endpoint (E)

Functions implementing various checks on the Endpoint Data (ED) are used to compute the Plausibility (P). Checks include among others:
Checks for integrity of dependencies used in the score computation. For example, considering this check under macOS: “defaults read /Library/Preferences/com.apple.alf globalstate|grep 0”
   Get/bin/defaults hash, path, and access rights (to test it against “normal” properties)
   Get com.apple.alf globalstate access rights (to test it against “normal” properties)
   Get grep hash, path, and access rights (to test it against “normal” properties)
   Get the full /Library/Preferences/com.apple.alf (to test it against “normal” content)
Analysis of the operational status of the checked security elements. For example:
   Endpoint Protection Platform (EPP) binary is present
   A given log shows content that demonstrates it's active
   An injection of a test threat and validation of its response
Explicit detection of tampering. For example:
   SSH disabled, yet recent artifacts of remote SSH access is present in the logs
   System Integrity Protection was disabled, and now enabled, yet no remediation has taken place
A threat model defining the way to compute the State (S) and the Plausibility (P) is stored in the Backend (B) with two structures:
   The State Validations (SV) and logic defining the State (S) (the “public” model). The public model is present on the Endpoint E (and the Backend (B)) in a readable form for user facing score expression and remediation. This model is not supposed to change frequently and is based on standard templates/profiles.
   The logic defining the Plausibility (P) and the Plausibility Validations (PV) to apply to the Endpoint Data (ED) (the “private” model). We refer it as the Dynamic Plausibility Model (DPM), which is:
      present on a trusted Endpoint Orchestrator element (EO) of the Endpoint Digital Arbiter (EDA) and is kept secret to ensure security of the Resources (R) of the Owner of Resource (OR);
      constantly modified by an operation process comprising humans and/or assistant software to keep an edge on potential attackers.

Extra Plausibility Validations (PV) can be performed by the Endpoint Digital Arbiter (EDA) across domain (like in the state of the art, as seen in Identity as a Service platforms like Azure AD). For example, those extra Plausibility Validations (PV) could use IP address reputation (like with https://talosintelligence.com/reputation_center/).

### Group Propagation of the State (S)

The State (S) and the Plausibility (P) of the Endpoint (E) can:
account for their relationship with the State (S) or the Plausibility (P) of other Endpoints (E);
be computed based on the State (S) or the Plausibility (P) of other Endpoints (E) in the same Local Area Network (LAN);
be computed based on the State (S) or the Plausibility (P) of other Endpoints (E) participating to the same application/project/group.

### Achieving Privacy Using Decentralization and Encryption

Privacy is achieved by strictly controlling the information that can be extracted from the Endpoint Data (ED) to compute the State (S) and the Plausibility (P). Each Endpoint (E) enrolled into the system has been provided with a unique device certificate (with its private key) by the Backend (B). The enrollment is done in a secure fashion.
Using a trusted certificate for initial authentication, for example, based on a mechanism like AWS's IoT “claim based provisioning”, or using the Simple Certificate Enrollment Protocol (SCEP) to communicate the certificates details with a backend Public Key Infrastructure (PKI).
Requiring sufficient initial guarantees of security of the Endpoint (E), for example, requiring a sufficient initial Security Posture (SP) represented by a State (S).

Each Endpoint (E) can distribute the Endpoint Data (ED) to the Endpoint Validators (EV) through the Endpoint Orchestrator (EO), in a privacy preserving form. The Endpoint Data (ED) are encrypted using homomorphic encryption or any other type of non-cleartext form supporting computation of Plausibility Validations (PV) without the need to access to cleartext versions of the Endpoint Data (ED). The originating IP address and identity of the Endpoint (E) can be obfuscated using intermediate hops, such To compute the State (S), we use a secured communication with the Backend (B) where:
the Endpoint (E) receives from a Backend (B) a challenge according to a given threat model and a nonce (SPN)
the State (S) is computed locally on the Endpoint (E) according to the threat model
to validate the State (S), we leverage the Backend (B) directly.

Optionally, communication of the State (S) to the Backend (B) can be secured with a Trusted Platform Model (TPM) if available.

Optionally, some protection against a possible tampering in the transmission of the State (S) by the Endpoint (E) can be provided by verifying its consistency versus an anonymized version of its components. For example, by leveraging the State (S) being an Integer and the associated State Validations (SV) being a series of Booleans of various weights and using homomorphic encryption:
Using Full Homomorphic Encryption (FHE) of a binary matrix;
Where the State (S) and its properties are transmitted as one property signed by a device certificate's private key and in a homomorphic encrypted fashion
The State (S) is re-computed from its properties in the Backend (B) on the encrypted properties and compared with the received score.
If the recomputed score is different from the transmitted score, the State (S) is invalidated

To compute the Plausibility (P), we use a decentralized approach involving the Endpoint Digital Arbiter (EDA) where:
At the request of the Endpoint Orchestrator (EO) and following Endpoint Data Specifications (EDS), the Endpoint (E) locally collects the Endpoint Data (ED), as a list of strings, binaries, or hashes to verify, that represents the set of parameters to apply to a given Plausibility Validations (PV). It associates an Endpoint Data Nonce (EDN) to each Endpoint Data (ED). The Endpoint (E) distributes the Endpoint Data (ED) and the Endpoint Data Nonce (EDN) as well as (SPN) to one or more Endpoint Validator (EV) through the Endpoint Orchestrator (EO). Optionally, a given Endpoint Data (ED) can be sent to multiple Endpoint Validators (EV) for process redundancy and extra validation.

Communication between peers is done as follow:
Endpoint Orchestrator (EO) acts as a rendezvous point for peer-to-peer
When communicating to a given Endpoint Validator (EV), the Endpoint (E) is encoding its communication using the public key of the Endpoint Validator (EV) that will make any message only understandable by the Endpoint Validator (EV). Endpoint Orchestrator (EO) can't read or store Endpoint Data (ED) as it only forwards them in an encrypted stream that it can't decode.

Endpoint Data (ED) are also further encrypted within the encrypted stream between the Endpoint (E) and Endpoint Validators (EV) in a form that supports mechanisms like Full Homomorphic Encryption, Multi Party Computation or Privacy Preserving Pattern Matching where:
Endpoint Validators (EV) obtain from Endpoint Orchestrator (EO) the associated encrypted Plausibility Validations (PV) to apply to the encrypted Endpoint Data (ED).
And without any possibility for Endpoint Validators (EV) to decrypt Endpoint Data (ED).
And without any possibility for Endpoint Validators (EV) to decrypt Plausibility Validations (PV).
And where the result of the Plausibility Validations (PV) is known to Endpoint Validators (EV) only.
   For example, Endpoint Data (ED) and Plausibility Validations (PV) are encrypted using keys generated by Endpoint Orchestrator (EO) and securely communicated to the Endpoint (E). According to another example, Endpoint Data (ED) is encrypted using a primary key generated by the Endpoint (E) and an associated secondary key generated by the Endpoint (E) and is communicated by the Endpoint (E) to the Endpoint Orchestrator (EO) for encryption of the Plausibility Validations (PV) and where the encrypted Plausibility Validations (PV) can be applied to the encrypted Endpoint Data (ED).

The Plausibility Validations (PV) takes Endpoint Data (ED) as one of their parameters and can be for example:
an arbitrary Multi Party Computation function;
a set of encrypted arithmetic operations using a form of Full Homomorphic Encryption;
an encrypted pattern to match or an encrypted regular expression to match using a form of Privacy-Preserving Pattern Matching;
a set of encrypted parameters associated with a function and its code.
any combination of the above;

The Plausibility Validations (PV) can be:
Stateless: the Plausibility Validation Computation History (PVCH) has no influence on the result of a given Plausibility Validation (PV)
Stateful: the Plausibility Validation Computation History (PVCH) is part of the parameters of a given Plausibility Validation (PV). The Plausibility Validation Computation History (PVCH) can be stored locally on Endpoint Validators (EV). Or for more security and flexibility, the Plausibility Validation Computation History (PVCH) can be sent along the results of the Plausibility Validations (PV) to the Endpoint Orchestrator (EO) in an encrypted form with a key only known to the Endpoint Validators (EV), and will be part of the parameters of a subsequent Plausibility Validation (PV).

Endpoint Validators (EV) perform given Plausibility Validation (PV) to given Endpoint Data (ED).

The individual Boolean results along with the nonce (SPN) and the peer's unique identity are encrypted with the peer's private key are sent back to the Endpoint Orchestrator (EO).

A plausibility (P) is calculated by Endpoint Orchestrator (EO) by aggregating the results of all the Plausibility Validations (PV) of a given nonce (SPN): if any of the result is FALSE or if any of the peers involved in the computation exhibits an abnormal score or plausibility then plausibility is set to FALSE.

Endpoint Data Nonce (EDN) are used to verify that all the checks have been completed at least once.

### Operation and Auditability of Software Components

The Endpoint Orchestrator (EO) is operated independently of the Backend (B) and will ensure an ability to maintain the quality of the certification of (SP) using (P) through Dynamic Plausibility Model (DPM) as it dynamically defines Endpoint Data Specification (EDS) and Plausibility Validation (PV) with an aim to make it hard for an attacker/adversary to tamper with the computation of the State (S). Endpoint Orchestrator (EO) can be operated by human operators. Operators can be assisted or replaced by assisting software components, including
Software providing statistical based selection of the Endpoint Data (ED) and the Plausibility Validations (PV).
Software providing Machine Learning based selection of the Endpoint Data (ED) and the Plausibility Validations (PV).

The Dynamic Plausibility Model (DPM) is dynamic but needs to follow a strict set of rules defining what's possible and not possible for the Endpoint Data Specifications (EDS) and the Plausibility Validations (PV). In particular, the Dynamic Plausibility Model (DPM) must not rely on any Personal Identifiable Information (PII).

Endpoint Orchestrator (EO) is operated in an environment that can be audited for compliance, in particular:
The source code of Endpoint Orchestrator (EO) can be made public without negative impact on the value of the solution.
The Dynamic Plausibility Model (DPM) is kept secret by Endpoint Orchestrator (EO) but is strictly logged and can be audited for compliance to its rules. For example, an audit could verify that the applied Plausibility Validations (PV) doesn't rely on any Personal Identifiable Information (PII).

The Software Agent (SA) running on the Endpoint (E) can be audited for compliance, in particular the source code of the Software Agent (SA) can be made public without negative impact on the value of the solution.

### Bootstrapping of Trust and Onboarding of Participating Endpoints

The supply chain for the Software Agent (SA), Endpoint Orchestrator (EO) and Endpoint Validators (EV) software components is trusted (see Threats and mitigation of “Endpoint Digital Arbiter (EDA) Supply Chain Attacks”) and operation of Endpoint Orchestrator (EO) is trusted (see Operation and auditability of software components)

Endpoint Orchestrator (EO) is hosted in a secured and controlled location, such as in a Trusted Computing Cloud Platform (TCCP) where not only the execution environment is trusted but also the execution dependencies are trusted.

Endpoint Validators (EV) are a combination of Endpoint Validation Bootstrap (EVB) and Participating Endpoints (PE), for example only Endpoint Validation Bootstrap (EVB) components and no Participating Endpoints (PE), or one of more Endpoint Validation Bootstraps (EVB) and multiple Participating Endpoints (PE).

Participating Endpoints (PE) can be part of a homogenous group based on a variety of criteria such as belonging to the same region, organization, Resources (R) they are looking to access . . .

Endpoint Validation Bootstrap (EVB) components are the root of a chain of trust for certification of the State (S). Endpoint Validation Bootstrap (EVB) is hosted in a secured and controlled location, such as in a (TCCP).

Eligible Participating Endpoints (PE) are Participating Endpoints (PE) whose security is satisfactory, such as for example an initial State (S) representing the Security Posture (SP) of the Endpoint (E) has been computed, deemed as sufficient and certified, to ensure for safe onboarding as a Participating Endpoint (PE). Eligibility is possibly requiring additional elements beyond the definition of(S) such as, a specific operating system or specific execution environment . . .

When Endpoint Validators (EV) includes Participating Endpoints (PE), the solution offers a way for any Participating Endpoint (PE) to opt in and opt out of the State (S) export and Plausibility Validations (PV) computation mechanisms. The Software Agent (SA) can be installed before opt-in and in that passive state it will compute a standard State (S) for Participating Endpoints (PE) but without any certification and therefore communication with other elements of the Endpoint Digital Arbiter (EDA). During that opt-in phase if other Participating Endpoints (PE) are not available to perform the certification process, the solution uses an Endpoint Validation Bootstrap (EVB). When a Participating Endpoints (PE) is onboarded, it enters an active state, and it communicates with other components of the Endpoint Digital Arbiter (EDA). At any point in time a Participating Endpoints (PE) can opt-out and in that case revert to a passive state.

### Dynamic Certification of the State (S) and Link to Conditional Access Control (CAC)

The State (S) and the Plausibility (P) are dynamically computed according to:
Changes in the definition of the State Function (SF): the Owner of Resource (OR) is expected to standardize its State Function (SF) and such a change will happen essentially in the case of the Endpoint (E) trying to access a different Resource (R).
Changes in the definition of the Plausibility (P): Endpoint Orchestrator (EO) operations are tasked to always maintain an edge against possible attackers and therefore are expected to update Validations Plausibility (PV) and Endpoint Data Specifications (EDS) in a frequent fashion. Possibly using an approach that would randomize at least a part of those changes for further protection against tampering.
A pre-defined frequency compatible with security requirements and scalability of the architecture, for example, every 5 minutes.
Indication of a possible tampering of the Endpoint Validator (EV) that participated to the computation of the current Plausibility (P) of a State (S). Such when the plausibility (P) of the State (S) of Participating Endpoint (PE) being an Endpoint Validator (EV) for the Endpoint (E) becomes FALSE.

When the State (S) is representing the Security Posture of the Endpoint (E), the State (S) and the Plausibility (P) can be used to grant or deny access to corporate resources using an external Conditional Access Control (CAC) mechanism controlled by the Owner of Resource (OR).
Such as Microsoft Azure AD or Microsoft Defender for Cloud Apps Conditional Access Control, Google Context Aware Access or using device or client certificate-based authentication in addition to user authentication.
It has a default “not plausible” stance: the State (S) will be invalidated, triggering a for example a denial of access to corporate content if any doubt exists with the State (S) through the Plausibility (P).
Using the following workflow:
   When registered in the solution a client/device certificate is generated and mapped with the device unique identity. The root Certificate Authority (CA) of the certificate is configured in the Conditional Access Control (CAC).
   When the user wants to access R, it explicitly presents its certificate
   Conditional access is configured as follow: If supported by the (CAC), (S) is exported by (B) to the (CAC) as a custom parameter for use with (CAC) rules (like Microsoft Endpoint Manager's device health attribute). And by default, the Backend (B) uses dynamic revocation/new issuance of the certificate to control access.

### Threat/Adversary Model of the Solution and Associated Mitigations

### Threats and Mitigation of “Endpoint Attacks”

We define “Endpoint Attacks” as security breaches of the Endpoint (E) from an attacker focusing on compromising the Endpoint (E) without being noticed by the Endpoint Digital Arbiter (EDA), i.e., without a negative impact on the State (S) calculation.

A possible attack is to tamper with any System Elements (SE) participating to the computation of the State (S) to render(S) inaccurate and allow unauthorized access of the Endpoint (E) to the Resource (R). We mitigate:
by verifying the integrity of the Endpoint Operating System (EOS), using Apple OS attestation for example.
by verifying the integrity of the System Elements (SE) associated software binaries, using remote binary attestation for example.

Another possible attack is to tamper with System Elements (SE) without impacting the integrity of the System Elements (SE) associated software binaries nor Endpoint Operating System (EOS), for example by killing the process of a given System Element (SE) or configuring the System Element (SE) in a malicious fashion. We mitigate by verifying the ability of the System Elements (SE) to function normally, for example, like checking logs of the System Elements (SE) for normal activity, or injecting a test, controlled payload as an input to the System Elements (SE) and verifying the expected output.

### Threats and Mitigation of “Endpoint Digital Arbiter (EDA) Security Attacks”

We define “Endpoint Digital Arbiter (EDA) Security Attacks” as security breaches of the Endpoint Digital Arbiter (EDA) from an attacker focusing on getting access to Resources (R) using tampering of Endpoint Digital Arbiter (EDA) components.

A possible attack is to compromise the Endpoint (E) before installation of the Software Agent (SA) associated with the Endpoint Digital Arbiter (EDA). We mitigate by onboarding the Endpoint (E) in a protected fashion, for example, by requiring a sufficient Security Posture (SP) defined by a state(S) to complete onboarding, or by requiring an attestation of Endpoint Operating System (EOS) before installation of the Software Agent (SA).

A possible attack is to tamper with the Software Agent (SA) to always expose a certain State (S) to the Backend (B). We mitigate by checking the integrity of the binaries of the Software Agent (SA) using signatures, also by using obfuscation of the State (S) computation code, also by using validation of the integrity of the computation of the State (S) using techniques like flow control attestation, also by implementing other in-app tampering protection/detection:
Preventing in-memory score tampering (“Immutability”): the in-memory score is obfuscated/encrypted (represented in memory not as a numerical value but as a complex structure)
Using system (hardware-based when possible) Secure Enclaves (SE) such as ARM Trust Zone when available
Using low level kernel hooks or modules if necessary Another possible attack is to disable the Software Agent (SA) and forging the Software Agent (SA) export of the State (S) to the Backend (B). We mitigate by using known techniques preventing any replay attacks and enabling endpoint impersonation resistance, for example, using the Endpoint Data Nonce (EDN) as proposed above.

Another possible attack is to compromise the Endpoint Validation Bootstrap (EVB) to bypass the Plausibility Validations (PV) and forge the Plausibility (P). We mitigate by having the Endpoint Validation Bootstrap (EVB) under a strict secured and auditable operation.

Another possible attack is to compromise a given Endpoint Validator (EV) to bypass the Plausibility Validations (PV) and forge the Plausibility (PV). We mitigate by using multiple, redundant Endpoint Validators (EV) to perform a given Plausibility Validation (PV) and by verifying the consistency of the multiple results. Additionally, when the Endpoint Validator (EV) is a Participating Endpoint (PE) that Security Posture (SP) has been previously validated through a State (S), shows signs of compromise afterwards (the Plausibility (P) is FALSE), we mark it unsafe and force revalidation of associated the Security Posture (SP).

Threats and mitigation of “Endpoint Digital Arbiter (EDA) Data Attacks” We define “Endpoint Digital Arbiter (EDA) Data Attacks” as endpoint data breaches of the Endpoint Digital Arbiter (EDA) from an attacker focusing on taking advantage of the Endpoint Digital Arbiter (EDA) components to capture Endpoint Data (ED).

A possible attack is to read endpoint information sent to participating peers. We mitigate by only exporting encrypted Endpoint Data (ED). We further mitigate by splitting Endpoint Data (ED) in multiple pieces spread across multiple Participating Endpoints (PE).

Another possible attack is to take control of Endpoint Orchestrator (EO) to use Plausibility Validations (PV) relying on parameters enabling extraction of unauthorized such as Personal Identifiable Information (PII). We mitigate by implementing a mechanism that logs any parameters or artifacts used by Plausibility Validations (PV).

### Threats and Mitigation of “Endpoint Digital Arbiter (EDA) Supply Chain Attacks”

We define “the Endpoint Digital Arbiter (EDA) Supply Chain Attacks” as a breach in the process of building and provisioning any of the Endpoint Digital Arbiter (EDA) critical components, in particular the Software Agent (SA) running on the Endpoint (E), the initial Endpoint Validation Bootstrap (EVB) and the Endpoint Orchestrator (EO).

A possible attack is to compromise the source code of the Software Agent (SA), Endpoint Orchestrator (EO) or Endpoint Validation Bootstrap (EVB) or any their dependencies. We mitigate by using a strict control of the contributions to the code and by using modern threat advisory for any of the dependencies, for example, such as provided by solutions like GitHub Enterprise.

Another possible attack is to compromise the delivery of the Software Agent (SA) on the Endpoints (E). We mitigate by leveraging distribution through application store and/or download spoofing prevention techniques, and/or by leveraging application remote attestation when available, for example, Apple App Attest.

Another possible attack is to compromise updates of Endpoint Orchestrator (EO) or Endpoint Validation Bootstrap (EVB) binary. We mitigate by having the Endpoint Orchestrator (EO) and Endpoint Validation Bootstrap (EVB) under a strict secured and auditable operation.

FIG. 3 shows the implementation of the method according to the invention. The Endpoint (E) is seeking access to a Resource (R) owned by the Owner of Resource (OR). The Endpoint (E) sends its state(S) to the Backend (B). Access is granted to the Endpoint (E) by the Owner of Resource (OR) when both the State (S) of the Endpoint (E) issued by the Backend (B) and the Plausibility (P) of the State (S) issued by the Endpoint Orchestrator (EO) are matching expectations of the Owner of Resource (OR). The Backend (B) requests the Endpoint Orchestrator (EO) to compute the Plausibility (P) of the State (S). The Endpoint Orchestrator (EO) orders the Endpoint (E) to transmit Endpoint Data (ED) to the Endpoint Validators (EV), including the Endpoint Validation Bootstrap (EVB), the Participating Endpoint 1 (PE1) and the Participating Endpoint 2 (PE2). The Endpoint (E) sends the Endpoint Data (ED) to the Endpoint Validators (EV) in a privacy preserving fashion. The Endpoint Orchestrator (EO) orders the Endpoint Validators (EV) to perform Verifications (V) on the Endpoint Data (ED) using privacy preserving techniques. More precisely, the Verifications (V) are Plausibility Validations (PV). The Endpoint Validators (EV) send back the result of the Validations (V) to the Endpoint Orchestrator (EO), that determines the Plausibility (P) of the State (S) and communicates said Plausibility (P) to the Backend (B). In turn the Owner of Resources (OR) grants or deny access to the Resource (R) by the Endpoint (E) according to the certified State (S).

In particular embodiments, the State (S) can be a Health Indicator (HI), such as a Mental Health Indicator, for example for wellness or burnout prevention, or a Physical Health Indicator, for example for substance free workplace or safety protocol adherence. The Endpoint Data (ED) can be a combination of physiological or psychological metrics captured or computed through the Endpoint (E), configured as a wearable device or an implant, or inter-connecting wearable devices or implants, including but not limited to Heart Rate Variation devices, sleep trackers, activity trackers, self-reported mood or stress level devices or software, breathalyzers devices, sweat sensor devices, smart patches, sensors for detecting the use of protective equipment or proximity sensors.

Other non-described or shown embodiments can be implemented within the scope of the invention, which is defined by the set of claims. Besides, technical features of the different embodiments can be, in whole or part, combined with each other. Thus, the method and systems can be adapted to the specific requirements of the application.

### GLOSSARY OF TERMS

(B) Backend
(CAC) Conditional Access Control
(DPM) Dynamic Plausibility Model
(E) Endpoint
(ED) Endpoint Data
(EDN) Endpoint Data Nonce
(EDS) Endpoint Data Specifications
(EDA) Endpoint Digital Arbiter
(EO) Endpoint Orchestration
(EOS) Endpoint Operating System
(EU) Endpoint User
(EV) Endpoint Validator
(EVB) Endpoint Validation Bootstrap
(H) Host
(HI) Health Indicator
(OR) Owner of Resources
(PII) Personal Identifiable Information
(P) Plausibility
(PF) Plausibility Function
(PVj) Plausibility Validations
(PX) Proximity
(R) Resource
(SA) Software Agent running on an Endpoint
(S) State
(SE) System Elements
(SF) State Function
(SP) Security Posture
(SPN) Security Posture Nonce
(SVi) State Validations
(TCCP) Trusted Cloud Computing Platform
(TP) Third Party
(UEM) Unified Endpoint Management
(VCH) Validation Computation History

1. A method to remotely certify a State (S) of an Endpoint from a Backend, involving an Endpoint Orchestrator and at least one Endpoint Validator to attest a plausibility of the State, wherein:
the Endpoint Validator is distinct from the Endpoint Orchestrator,
the State is based on a series of State Validations (SVi) and a State Function (SF), such that S=SF (SVi),
the State is known to the Backend and the Endpoint,
the State Function is known to the Backend and the Endpoint,
the series of State Validations are unknown to the Backend but known to the Endpoint,
and wherein the method comprises
verifying the Plausibility (P) of the State with the following conditions:
the Plausibility represents an analysis of information within the Endpoint that supports the accuracy of the State,
the Plausibility is known to the Backend through Endpoint Orchestrator,
the Plausibility is based on a series of Plausibility Validations (PVj) and a Plausibility Function (PF), such that P=PF(PVj),
the Plausibility Function and the Plausibility Validations are updated in a dynamic fashion,
the Plausibility Function and the Plausibility Validations are unknown to the Backend, to protect a privacy of the Endpoint,
the Plausibility Function is unknown to the Endpoint, to make tampering of the Plausibility difficult,
the Plausibility Function is computed by the Endpoint Orchestrator, and
the Plausibility Validations are computed by the Endpoint Validator based on a series of Endpoint Data that are unknown to any party except the Endpoint.

2. The method according to claim 1, wherein the Endpoint Validator is made of one or more Participating Endpoints orchestrated by the Endpoint Orchestrator having a second State previously certified.

3. The method according to claim 1, wherein the State is a Security Posture.

4. The method according to claim 1, wherein the State is a Health Indicator.

5. The method according to claim 2, wherein the State is a Health Indicator, wherein the second State is a Security Posture, and wherein the Endpoint Validator for validating the Health Indicator is made of one or more Participating Endpoints orchestrated by the Endpoint Orchestrator, whose Security Posture has been previously certified.

6. The method according to claim 2, wherein an exposure of the Endpoint Data to potential unauthorized access is inverse to a proximity between the Endpoint Validator and the Endpoint, and wherein the proximity is chosen inferior to a predetermined threshold.

7. The method according to claim 6, wherein the proximity is a geographical parameter.

8. The method according to claim 6, wherein the proximity is a legal parameter.

9. The method according to claim 1, wherein the Plausibility Function and the Plausibility Validations are kept secret by the Endpoint Orchestrator but can be audited for compliance to privacy of the Endpoint.

10. The method according to claim 1, wherein the Plausibility Function and the Plausibility Validations are dynamically defined by human operators, software components, or both human operators and software components.

11. The method according to claim 1, wherein the Plausibility Validations (PVj) are computed using, a series of Endpoint Data (EDj) captured according to a series of Endpoint Data Specifications on the Endpoint and, a series of Parameters (PAk) only known to the Endpoint Orchestrator to make tampering of the Plausibility difficult, wherein:
PVj=PFj (EDj, PAk),
the series of Endpoint Data Specifications and the series of Parameters are available for an audit of compliance to the privacy of the Endpoint.

12. The method according to claim 11, wherein:
the Endpoint Validator only has access to a non-cleartext version of at least part of the Endpoint Data (EDj) and a non-cleartext version of at least part of the series of Parameters (PAk) and
the Plausibility Function PFj (EDj, Pak) is a function supporting operations on non-cleartext parameters.

13. The method according to claim 12, wherein the Plausibility Validations PVj=PF (EDj, PAk) and the Plausibility Function is a function returning a result and a Validation Computation History-(VCH) that can be used for stateful computation of the Plausibility Function where the Validation Computation History is sent to the Endpoint Orchestrator and aggregated to the series of Parameters in an encrypted form and only readable by the Endpoint Validator(s).

14. The method according to claim 13, wherein the Plausibility Validations PVj=PF (EDj, PAk) and the Plausibility Function is a function enabling Privacy Preserving Pattern Matching of the Endpoint Data and the series of Parameters are patterns to match, where the Endpoint Validator(s) only have access to a non-cleartext version of the Endpoint Data and a non-cleartext version of the series of Parameters.

15. A system to remotely certify a State of an Endpoint from a Backend, the system comprising:
an Endpoint Orchestrator (EO); and
at least one Endpoint Validator to attest a plausibility of the State wherein:
the Endpoint Validator-(EV) is distinct from the Endpoint Orchestrator
the State (S) is based on a series of State Validations (SVi) and a State Function (SF), such that S=SF (SVi),
the State is known to the Backend and the Endpoint,
the State Function is known to the Backend and the Endpoint,
the series of State Validations are unknown to the Backend but known to the Endpoint,
and wherein the system is configured to verify the Plausibility of the State with the following conditions:
the Plausibility represents an analysis of information within the Endpoint that supports the accuracy of the State,
the Plausibility is known to the Backend through the Endpoint Orchestrator,
the Plausibility (P) is based on a series of Plausibility Validations (PVj) and a Plausibility Function (PF), such that P=PF (PVj),
the Plausibility Function and the Plausibility Validations are updated in a dynamic fashion,
the Plausibility Function and the Plausibility Validations are unknown to the Backend, to protect privacy of the Endpoint,
the Plausibility Function is unknown to the Endpoint, to make tampering of the Plausibility difficult,
the Plausibility Function is computed by the Endpoint Orchestrator,
the Plausibility Validations are computed by the Endpoint Validators based on a series of Endpoint Data that are unknown to any party except the Endpoint.
